(19) United States
(12) Patent Application Publication
(10) Pub. No.: US 2005/0162139 A1
(43) Pub. Date: Jul. 28, 2005

(54) Alternating current switching circuit

(76) Inventor: Mark Hirst, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/763,664

(22) Filed: Jan. 23, 2004

(51) Int. Cl. G05F 1/10

(52) U.S. Cl. 323/239

(57) ABSTRACT

An alternating current (AC) switching circuit comprises a first Field Effect Transistor (FET) having a first source, a first gate and a first drain and a second FET having a second drain, a second source coupled to the first source and a second gate coupled to the first gate. The AC switching circuit also comprises a first diode coupled to the first source and first drain and a second diode coupled to the second source and second drain.

### BACKGROUND

Alternating Current (AC) power control provides a unique set of challenges to those working in the field. There are few solid state electrical devices, such as thyristors and triacs, that will allow AC power to be controlled directly. For both thyristor and triacs the switching times are comparatively long. These long switching times typically limit these devices to low frequency applications, typically AC frequencies of 50-60 Hz. Additionally, full wave rectification to convert AC to direct current (DC), to facilitate work with DC, can result in, among other things, undesirable current harmonics and high frequency conducted emissions that, if not filtered, result in unacceptable noise going back to the power company on the AC power supply lines.

### BRIEF DESCRIPTION OF THE DRAWINGS

Embodiments of the present invention will be described referencing the accompanying drawings in which like references denote similar elements, and in which:

FIG. 1 illustrates an AC MOSFET switch, including anti-parallel diodes, in accordance with one embodiment.

FIG. 2 illustrates a more detailed look at an AC MOSFET switch, including intrinsic parasitic diodes of the MOSFETs, in accordance with one embodiment.

FIG. 3 illustrates current that is delivered to a load when one embodiment of the AC MOSFET switch is utilized to control current.

FIGS. 4A-4C illustrate a power filter and its effects on the current drawn by a load driven by an AC MOSFET switch, in accordance with one embodiment.

FIG. 5 illustrates an AC MOSFET switch design including a snubbing device, in accordance with one embodiment.

FIG. 6 illustrates a single IC device containing two NMOS type MOSFET devices of an AC MOSFET switch, in accordance with one embodiment.

### DETAILED DESCRIPTION OF EMBODIMENTS

Although specific embodiments will be illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims.

The following discussion is presented in the context of MOSFET devices. It is understood that the principles described herein may apply to other transistor devices.

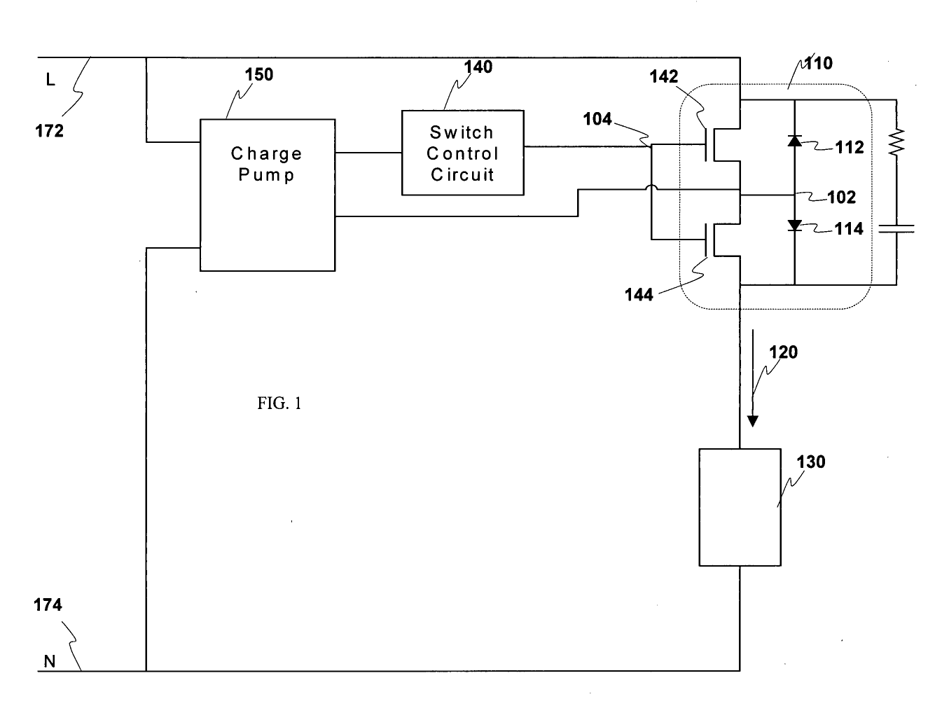

Refer now to FIG. 1 wherein an AC MOSFET switch 110, including anti-parallel diodes 112 114, is illustrated, in accordance with one embodiment. For the MOSFETs 142 144 illustrated, the sources of the MOSFET devices are coupled at junction 102. In one embodiment, MOSFETs 142 144 are power MOSFETs. In addition, the gates are electrically coupled at junction 104. These couplings are to facilitate the operation of the two MOSFETs 142 144 as a single AC MOSFET switch. Thus, by applying a gate to source voltage, V_{GS}, greater than the threshold voltage, V_{TH}, to the two MOSFETs 142 144, both MOSFETs conduct current 120.

Also illustrated in FIG. 1 are two diodes 112 114. These diodes 112 114, which may be parasitic or explicit, are anti-parallel to their respective MOSFETs. As described in further detail below, these diodes 112 114 may be utilized to bypass the intrinsic anti-parallel diodes of the MOSFETs. Thus, as illustrated, the anodes of the diodes 112 114 are coupled to the sources of the diodes' respective MOSFET and the cathodes are coupled to the respective drains.

FIG. 1 also illustrates the AC MOSFET switch in use in controlling power to a load. As previously mentioned, AC MOSFET switch 110 comprises two MOSFETs 142 144. AC MOSFET switch 110 controls current 120 through load 130. This may be accomplished by switch control circuit 140 which applies the gate-source voltages for the two MOSFETs 142 144 forming the AC MOSFET switch 110. In the embodiment illustrated, charge pump biasing circuit 150 supplies current to switch control circuit 140 from line (L) 172 and neutral (N) 174 connections of the AC power source.

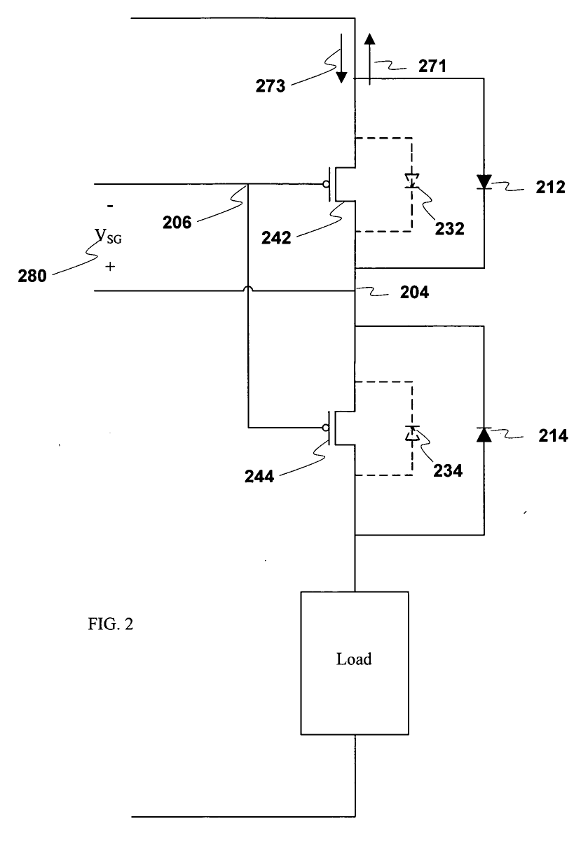

FIG. 2 illustrates a more detailed look at an AC MOSFET switch, utilizing P type MOSFETs, including intrinsic parasitic diodes 232 234 of the MOSFETs 242 244, in accordance with one embodiment. Also illustrated are antiparallel diodes 212 214 which may be utilized to bypass the intrinsic anti-parallel diodes 232 234 of the MOSFETs. Note that the sources of both MOSFETs 242 244 are coupled 204 to each other. In addition, the gates of both MOSFETs 242 244 are coupled 206 to each other. When a voltage, V_{SG} 280 less than a threshold voltage V_{TH} is applied, the MOSFETs 242 244 will be “turned-off” and the internal reverse biased PN junctions will substantially prevent current from flowing through the MOSFETs.

When a voltage, V_{SG} 280 greater than a threshold voltage V_{TH} is applied to the common sources and gates of MOSFETs 242 244 are turned on to facilitate the flow of current through the AC MOSFET switch. Note that current will flow in the reverse direction in MOSFET 242 or 244 depending on the polarity of the AC voltage source. That is, in the reverse direction as is normally used in DC circuits, that is drain to source in an N type MOSFET or source to drain in a P type MOSFET. The reverse current flow causes no problem as the MOSFET transistor is truly a bidirectional device, that is, current may flow from drain to source or source to drain once the proper gate voltage is applied and the conductive channel forms. Normally, during reverse polarity across the source/drain of a MOSFET, an internal PN junction, represented by parasitic diodes 234 and 232 in FIG. 2, will eventually turn on allowing current 271 to flow. Note that parasitic diodes 234 and 232 are not separate from the MOSFET 244 and 242; e.g. parasitic diode 234 is a PN junction that is part of the structure of transistor 244. Once the gate voltage is removed the parasitic diode conducts during reverse current flow which makes a single MOSFET unsuitable for the control of alternating current 271 273. The common source configuration of MOSFET 242 and 244 of FIG. 2 results in one of the parasitic diodes in a reverse biased state which substantially prevents current flow through the parasitic diodes 232 234 when the MOSFETs are in either the conducting or nonconducting states.

Referring again to FIG. 1, switch control circuit 140 and charge pump circuitry 150 are utilized to provide control for the application of the voltage to the gates of MOSFETs 142 144. In the embodiment illustrated, switch control circuit 140 may be an externally controlled pulse width modulation circuit. In the embodiment illustrated, charge pump 150 utilizes the AC line to power the pulse width modulation circuitry. In addition, the frequency of the modulated control signal may be fixed, whereas the duty cycle of the modulation, as described below, is utilized to determine the power to be delivered to the load 130. In an alternative embodiment the gate and source of the AC MOSFET may be driven by a circuit which has a minimum conduction time combined with a variable frequency to determine the power to be delivered to the load 130.

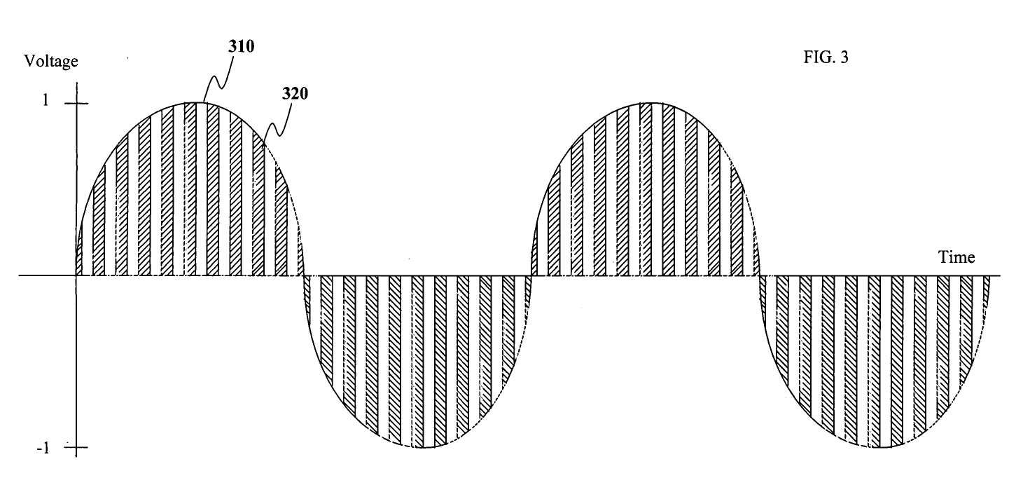

FIG. 3 illustrates current that is delivered to a load when one embodiment of the AC MOSFET switch is utilized to control current. For example, as discussed above with respect to FIG. 1, the switch control circuit 140 may be a pulse width modulation circuit. In such a case, the power delivered to the load 130 can be controlled by changing the duty cycle of the pulse control signal. FIG. 3 illustrates an example input voltage 310 from the line and neutral. Illustrated also, in the dark shaded regions 320, are the periods where the AC MOSFET switch 110 is switched on to allow current to flow through the load 130. The voltage 310 and current 320 are normalized so that they share a common envelope. Thus, in the illustrated embodiment, a 50% duty cycle signal driving the gate to source voltage will result in an effective power of one half the total power available being delivered the load. By utilizing a pulse width modulation technique, the level of power delivered to the load can be adjusted by controlling the width of the pulses generated by the pulse width modulation of the switch control circuit. The equation governing the power transfer to the load is:

$$Pavg = \frac{{Vrms}^{2}}{R} \cdot d .$$

Where Vᵣₘₛ is the Root Mean Square (rms) voltage of the AC power source, R is the resistance of the load and d is the duty ratio of the pulse width modulator driving the AC MOSFET. By inspection of this equation, the power transferred to the load is a linear function of the duty ratio of the pulse width modulator. The load is at zero power when the duty ratio is zero and at maximum power when the duty ratio is 1.

In an alternative embodiment in which the gate and source of the AC MOSFET switch are driven by a circuit which has a minimum conduction time combined with a Variable Frequency Oscillator (VFO) the power delivered to the load 130 is determined by
P=V²÷R×f×Tₘᵢₙ
Where V is the rms voltage of the AC power source, R is the resistance of the load, f the frequency of the VFO driving the AC MOSFET and Tₘᵢₙ the minimum conduction time allowed. By inspection, this equation shows that the power transferred to the load is a linear function of the frequency of the VFO. The load is at zero power when the VFO frequency is 0 and at maximum power when the period of the frequency of the VFO is equal to or less than the minimum allowed conduction time Tₘᵢₙ.

The above examples operate to facilitate the switching of the alternating current at relatively higher frequencies. There are advantages to switching the current at relatively higher frequencies. Switching frequencies out of the audio range (e.g. greater than 20 KHz) can be utilized to reduce human factor issues associated with audible switching noise. Another advantage of operation at higher frequencies may be a reduction in switching and conduction losses. Implementations operating at significantly lower frequencies spend more time in the linear region of operation. Spending more time in the linear region during switching may dissipate significant amounts of additional energy in the form of heat as relatively slow transitions are made through this linear region. In addition, because of the relatively low voltage drops associated with the disclosed switching of alternating current, less energy is dissipated from the product of the current flowing across the voltage drops of the devices. In addition, the AC MOSFET switching circuit above does not introduce significant harmonics into the alternating current. This can reduce costs associated with filtering these harmonics to meet international regulatory requirements.

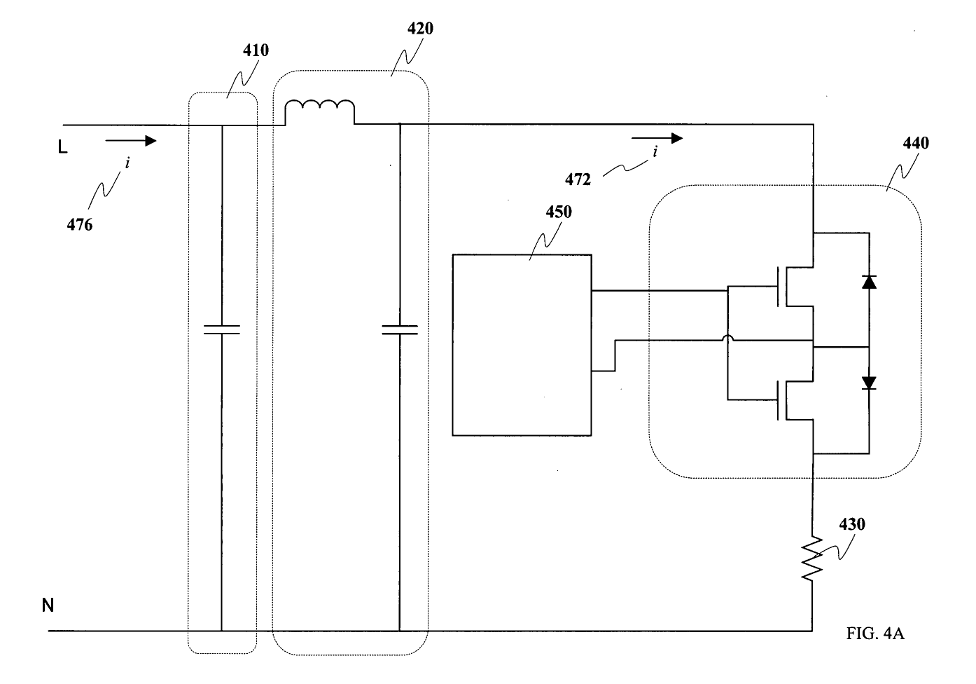

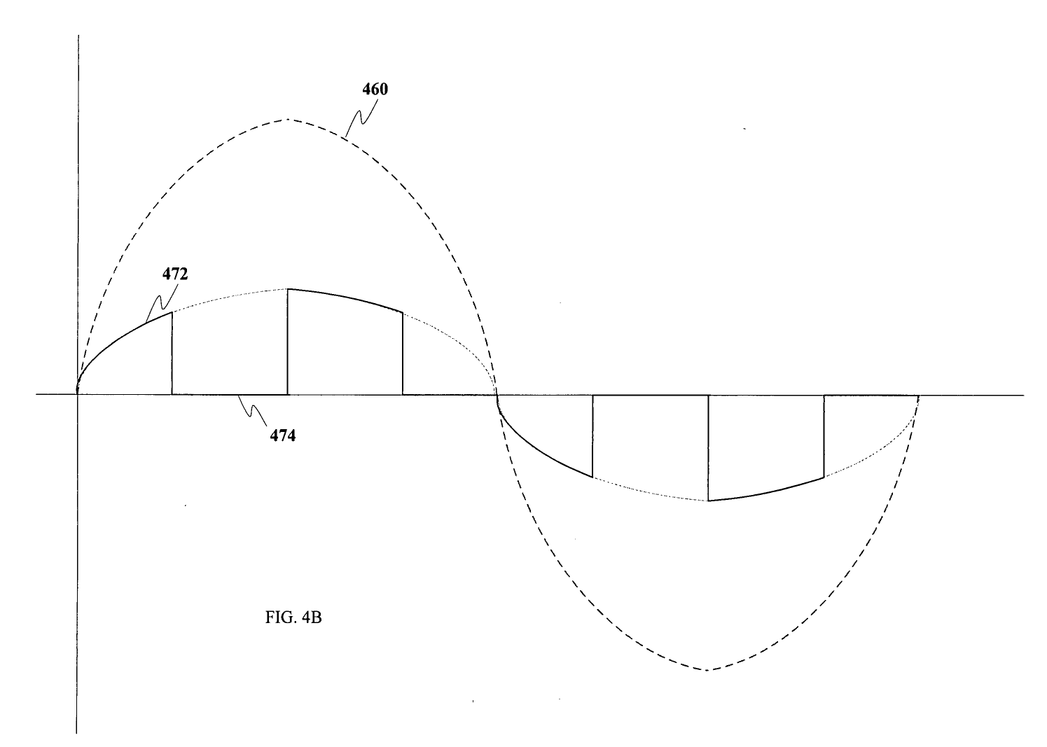

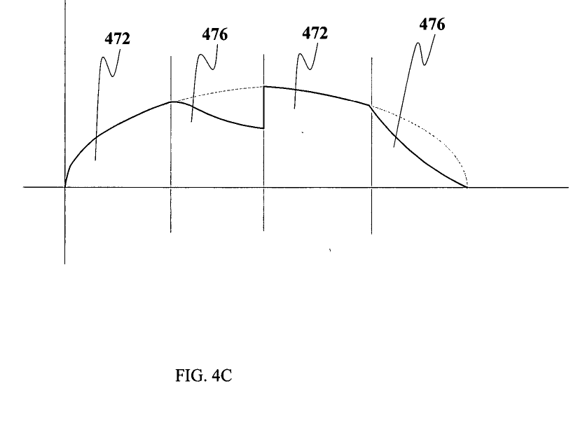

FIG. 4A illustrates input circuitry for an AC MOSFET switch, in accordance with one embodiment. Illustrated is a filter stage 410 to provides a high frequency short to ground to any transients or conducted emissions that occur across the inputs. Illustrated also is a filtering stage 420 to provide smoothing of the alternating current drawn by the load 430. The effect of this filter is to smooth the harmonic rich current drawn by the pulse width modulated, or VFO driven load, such that the power source experiences a continuous current flow with virtually no harmonic current content.

In the embodiment, switch control circuit 450 switches the current 472 delivered to the load as illustrated in FIG. 4B. During times of switching, assuming a purely resistive load, the current 472 through the load 430 will follow the line voltage provided, that is, it will be in phase. When the switch is turned off, the current delivered to the load will drop to zero 474. Thus, as can be seen there will be dramatic shifts or steps in the current drawn by the load as the switch turns on and off. These step changes in the current represent unwanted current harmonics placed on the AC power source which may exceed regulatory limits. To solve this problem, filtering stage 420 is added to the circuit. FIG. 4C illustrates the current drawn from the AC power source at the line and neutral connections by the switched load as a result of the filtering stage 420. When the switch is turned off, the filtering stage 420 smoothes current 476 drawn by the load 430. In the case in which the switch is driven by a pulse width modulator, the total instantaneous current drawn by the circuit may be the sum of the fundamental current and the instantaneous value of the ripple current. This instantaneous current may be expressed as

$${i}_{L} ( t ) = \frac{V \cdot d}{R} \cdot sin ( 2 \cdot π \cdot {f}_{o} \cdot t ) + \frac{{π}^{2}}{4} \cdot ( 1 - d ) \cdot {( \frac{{f}_{c}}{{f}_{s}} )}^{2} \cdot \frac{V \cdot d}{R} \cdot sin ( 2 \cdot π \cdot {f}_{o} \cdot t ) \cdot sin ( 2 \cdot π \cdot {f}_{s} \cdot t ) .$$

where f_{C} is the resonant frequency of filtering stage 420, f_{S} is the switch frequency of the pulse width modulator, f_{O} is the frequency of the AC power source, d is the duty cycle of the pulse width modulator, V is the peak source voltage, and R is the load resistance 430. Under direct examination of this equation it is noted that, as the switch frequency of the pulse width modulator is increased, the resultant alternating current waveform at the Line and Neutral connections smoothes dramatically.

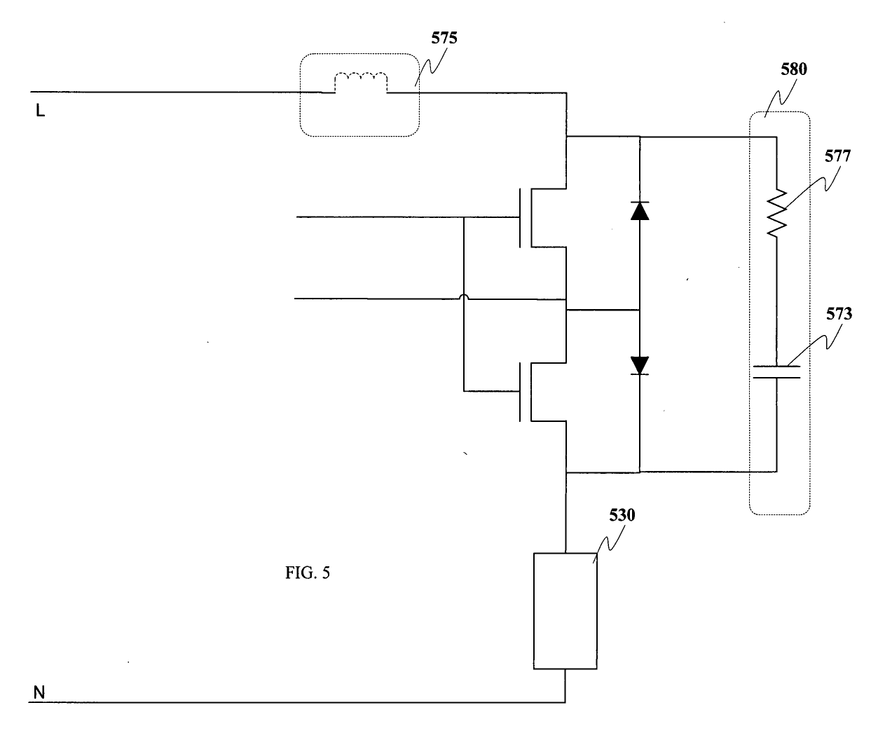

FIG. 5 illustrates an AC MOSFET switch design including a snubbing device 580, in accordance with one embodiment. Snubbing device 580 is utilized for dissipating energy stored in the circuit. Stored energy in a circuit exists due to various factors associated with the circuit such as: parasitic inductance associated with the wiring providing the AC current, parasitic inductance in the components leads, and inductance in the load itself. Snubber designs are designed to capture a portion of the stored energy in a circuit, when the circuit is switched off. These snubber designs are to reduce, among other things, the resonance of the circuit. However, these snubber designs are not engineered to dissipate all the energy; they are simply designed to dissipate enough energy to reduce resonance and the resulting resonant “over” voltages that may otherwise occur.

To dissipate all the energy in the circuit, a significantly larged sized capacitor 573 may be used in snubber 580 design. It is desirable to have the resistance 577 approximately match the resistance in the load 530. Thus, if the load resistance is approximately 20 ohms, then the resistance of the snubber should be selected to be about 20 ohms. In addition, the stored inductance 575 for a typical circuit driving the AC MOSFET switch has been measured at approximately 100 nanoHenries. In some snubber designs, a capacitor capable of capturing about ⅕ of the energy stored in the inductive parasitics may be utilized. As mentioned, this capacitor size is utilized to simply avoid resonance of the circuit. However, the remaining energy is dissipated via heat in the switching element or as Radio Frequency (RF) emissions. To avoid this heat or RF emissions, a larger snubber circuit may be utilized.

In order to have the snubber dissipate substantially all the stored energy of the circuit, the energy dissipated by the snubber should equal the energy stored due to the inductance of the circuit. Thus,
½ LI²=½ CV², where I=V/R
½ L(V/R)²=½ CV²
Solving for C we find that:
C=L/R²
Thus, the capacitor used is directly related to the value of the parasitic inductance.

Dissipating heat may be undesirable as it may result in damage to the circuit. A solution to this may be to include a heat sink. However, the addition of the heat sink may add cost to the design. In addition, generation of RF emissions may be undesirable as it may result in poor classification during RF certification proceedings for the device containing the AC MOSFET switch. To protect from RF emissions, a shield for the RF emissions may be provided. Again, however, the addition of a shield may add cost to the design.

Thus, in one embodiment, the capacitor that is part of the snubber illustrated in FIG. 5 is designed to capture substantially all of the stored energy in the circuit associated with the AC MOSFET switch. In this manner, the design of RF shield and the design of any heat dissipating devices may be reduced.

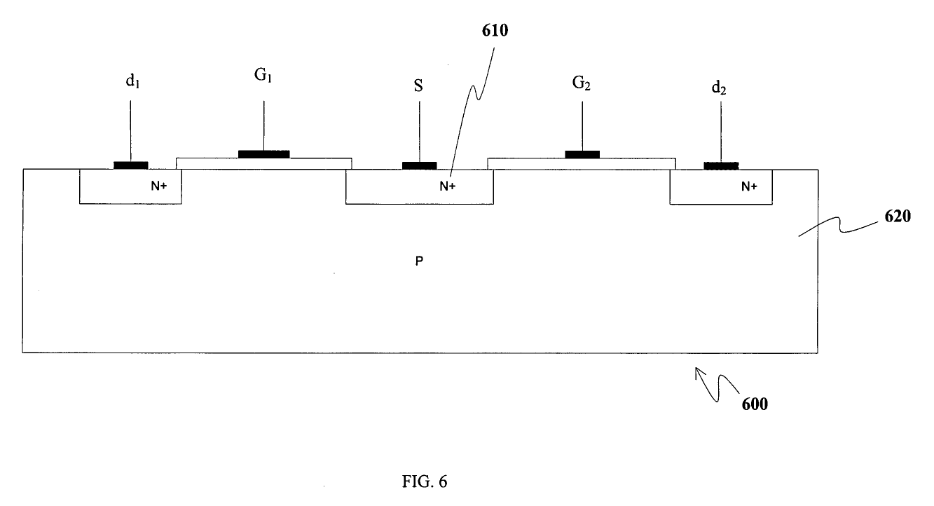

FIG. 6 illustrates a single integrated circuit (IC) device 600 containing two NMOS type MOSFET devices of an AC MOSFET switch, in accordance with one embodiment. In an alternative embodiment, two PMOS type MOSFET devices may be utilized in the construction of an AC MOSFET switch. Recall that the two sources from the two MOSFETs are logically coupled to each other in the AC MOSFET switch. By fabricating the two MOSFETs in a single package on an IC, the two MOSFETs may share a common source region 610 on the IC. In the embodiment illustrated in FIG. 6, a common source region 610 is implanted into the die containing the AC MOSFET switch. The sharing of the common source region 610 may allow the use of a single source lead emanating from the package containing the two MOSFETs of AC MOSFET switch. This, in turn, may result in decreased conduction resistance due to the elimination of one source lead and the source lead's associated wire bonding parasitics, such as ohmic resistance from the die to a package lead. For example, in one embodiment, the elimination of one of the source leads may reduce the impedance by 70 milliohms, corresponding to the impedance associated with one of the leads to the AC MOSFET switch.

70 milliohms may be a substantial portion of the overall resistance associated with the AC MOSFET switch. For example, assume an R_{DSON} of 100 milliohms for each MOSFET in the AC MOSFET switch. Thus, with a 70 milliohm resistance for each lead for the source and drain, the overall path impedance across the source and drain is 240 milliohms. Two discrete series devices have an effective resistance through the AC MOSFET switch of 480 milliohms. Recall that the external source lead in the AC MOSFET is used for the application of gate bias and as a conduction path for certain types of snubber applications during switch turn off. By design the external source connection 610 has very low current flow and does not introduce series resistance to the AC MOSFET switch when the switch is conducting. This fact allows the conduction resistance of the AC MOSFET switch to be reduced by 140 milliohms, or a reduction in effective resistance 30% by using a common source region on the die of the AC MOSFET and the elimination of one lead. Since the power dissipated is directly related to the resistance, this results in a 15% reduction in power loss, for the embodiment described. Fabrication of the AC MOSFET switch on a single die also allows one of the gate terminals of the discrete implementation to be eliminated. The result of the common source region and eliminated gate terminal is a four pin device with two high current drain connections and two lower current gate and source connections. One pin of the four pin device is coupled to each of the gates of the two MOSFETs. Another pin is coupled to the common source region, and each of the two remaining pins are coupled to a different one of the drains.

Thus, embodiments of an AC MOSFET switch design have been disclosed. This design generally allows for faster operation of the AC MOSFET switch to, among other things, allow operation significantly above the audio frequency spectrum (e.g. greater than 20 kHz). The AC MOSFET switch operation generally utilizes higher frequencies which, in turn, allows the device to be used in a broad range of AC power control, thus reducing the use of rectification and the resulting induction of harmonics to the power line. These advantages reduce the use of expensive filtering and allow for better operation in environments containing persons such as the home or office environment. The designs may also allow for single IC design of the AC MOSFET switch in many applications. This may reduce the number terminal thus reducing loss due to lead resistance.

1. An alternating current switching circuit comprising:
a first Field Effect Transistor (FET) having a first source, a first gate and a first drain;
a second FET having a second drain, a second source coupled to said first source and a second gate coupled to said first gate;
a first diode having a first anode coupled to said first source and a first cathode coupled to said first drain; and
a second diode having a second anode coupled to said second source and a second cathode coupled to said second drain.

2. The device of claim 1 wherein said first FET and said second FET are N type MOSFETs.

3. The device of claim 1 wherein said first FET and said second FET are power MOSFETs.

4. The device of claim 1 wherein said first diode and said second diode include turn-on voltages less than or equal to 1.2 volts.

5. An alternating current switching circuit comprising:
a first Field Effect Transistor (FET) having a first source, a first gate and a first drain;
a second FET having a second drain, a second source coupled to said first source and a second gate coupled to said first gate;
a first diode having a first anode coupled to said first drain and a first cathode coupled to said first source; and
a second diode having a second anode coupled to said second drain and a second cathode coupled to said second source.

6. The device of claim 5 wherein said first FET and said second FET are P type MOSFETs.

7. The device of claim 5 wherein said first FET and said second FET are power MOSFETs.

8. A device comprising:
an alternating current switching circuit including:
a first Field Effect Transistor (FET) having a first source, a first gate and a first drain,
a second FET having, a second drain, a second source coupled to said first source and a second gate coupled to said first gate,
a first diode having a first anode coupled to said first source and a first cathode coupled to said first drain; and
a second diode having a second anode coupled to said second source and a second cathode coupled to said second drain; and
a switch control circuit coupled to said first gate and said second gate and coupled to said first source and said second source, said switch control circuit to facilitate operation of said alternating current switching circuit at frequencies greater than 200 Hz.

9. The apparatus of claim 8 further comprising a load coupled to said alternating current switching circuit, wherein said switch control circuit facilitates pulse width modulation of current through said load.

10. The apparatus of claim 8 further comprising a resistor and capacitor circuit coupled to said first drain and said second drain.

11. The apparatus of claim 10 wherein said resistor and capacitor circuit is designed to dissipate substantially all stored energy in said alternating current switching circuit.

12. The apparatus of claim 8 further comprising charge pump circuitry coupled to an alternating current power source and said switch control circuit.

13. The apparatus of claim 8 further comprising filtering circuitry to facilitate current flow through said load.

14. The apparatus of claim 8 wherein said switch control circuit is configured to operate said alternating current switching circuit at frequencies greater than 20 kHz.

15. In an integrated circuit, an alternating current switching circuit comprising:
a first Field Effect Transistor (FET) having a first gate, a first drain, and a common source;
a second FET having a second gate, a second drain and said common source;
a first diode having a first anode coupled to said common source and a first cathode coupled to said first drain; and
a second diode having a second anode coupled to said common source and a second cathode coupled to said second drain.

16. The alternating current switching circuit of claim 15 wherein said first gate is coupled to said second gate.

17. The alternating current switching circuit of claim 15 further comprising a series resistor and capacitor circuit coupled to said first drain and said second drain.

18. The alternating current switching circuit of claim 17 wherein said series resistor and capacitor are designed to dissipate substantially all stored energy in said alternating current switching circuit.

19. The alternating current switching circuit of claim 15 wherein said first gate is coupled to said second gate and wherein said alternating current switching circuit further comprises a switch control circuit coupled to said coupled gates and said common source, said switch control circuit to facilitate operation of said alternating current switching circuit at frequencies greater than 200 Hz.

20. The alternating current switching circuit of claim 15 wherein said first FET and said second FET are power MOSFETs.

21. The alternating current switching circuit of claim 15 wherein said first FET and said second FET are N-type MOSFETs.

22. The alternating current switching circuit of claim 15 wherein the integrated circuit comprises a four pin device having a first pin coupled to said first and said second gate, a second pin coupled to said common source, a third pin coupled to said first drain and a fourth pin coupled to said second drain.

23. An alternating current switching circuit comprising:
a first Field Effect Transistor (FET) having a first source, a first gate and a first drain;
a second FET having a second drain, a second source coupled to said first source and a second gate coupled to said first gate;
a first diode having a first anode coupled to said first source and a first cathode coupled to said first drain; and
a second diode having a second anode coupled to said second source and a second cathode coupled to said second drain,
wherein said first and said second FETs receive an alternating current at said first and said second drain and wherein said coupled first and second source and said coupled first and second gate to facilitate switching said alternating current through said alternating current switch.

24. The device of claim 23 wherein said first diode and said second diode include turn-on voltages less than or equal to 1.2 volts.

25. A method of switching alternating current comprising:
receiving alternating current (AC) from a source;
switching said alternating current utilizing a MOSFET switch having two MOSFET devices with coupled sources and coupled gates and diodes antiparallel to each MOSFET device; and
controlling the switching of said alternating current, by said MOSFET switch, at frequencies greater than 200 Hz.

26. The method of claim 25 further comprising providing switched AC to a load.

27. In an integrated circuit, a method of switching alternating current comprising:
receiving alternating current (AC) from a source; and
applying said alternating current across drains of two MOSFET devices of a switch, where the two MOSFET device having a common source region, and their gates are coupled together, and the switch further having diodes that are antiparallel to each MOSFET device, flowing said alternating current though said common source region.

28. A device comprising:
means for switching alternating current; and
means for controlling switching coupled to said means for switching alternating current, said means for controlling switching to facilitate operation of said means for switching alternating current at frequencies greater than 200 Hz.
